(19) United States
(12) Patent Application Publication
(10) Pub. No.: US 2008/0098844 A1
(43) Pub. Date: May 1, 2008

(54) SHIFT LEVER DEVICE

(75) Inventors: Masashi KATO, Niwa-gun (JP); Kenichi TAKEUCHI, Nissin-shi (JP)

Correspondence Address: ROBERTS, MLOTKOWSKI & HOBBES, P. O. BOX 10064, MCLEAN, VA, 22102-8064, US

(73) Assignees: KABUSHIKI KAISHA TOKAI-RIKA-DENKI-SEISAKUSHO, Aichi-ken (JP); TOYOTA JIDOSHA KABUSHIKI KAISHA, Aichi-ken (JP)

(21) Appl. No.: 11/865,567

(22) Filed: Oct. 1, 2007

(30) Foreign Application Priority Data
Oct. 26, 2006 (JP) 2006-291130

(51) Int. Cl. G05G 1/04

(52) U.S. Cl. 74/473.18

(57) ABSTRACT

A control lever may be prevented from moving from a particular shift position when a shift lever is moved from a particular shift position in an automated gear change mode selection area, and a coupled state with the shift lever has been released. In a shift lever device, when a shift lever moves from the D position that is in an automatic gear change area to a manual gear change area, coupled to this movement, a striker plate slides along a width direction from a released position to a constrained position. In doing so, a stopper member prevents movement along a shift direction of the striker plate that is in the constrained position, preventing movement along the shift direction of a support lever, which has been integrated to the striker plate moving in the shift direction, and the shift lever.

### CROSS-REFERENCE TO RELATED APPLICATION

This application claims priority under 35 U.S.C 119 from Japanese Patent Application No. 2006-291130, the disclosure of which is incorporated by reference herein.

### BACKGROUND OF THE INVENTION

1. Technical Field

The present invention relates to a shift lever device for a vehicle such as an automobile or the like, and in particular to a shift lever device for changing gears in a transmission of a vehicle.

2. Related Art

A shift lever device for shift changing an automatic gear change for an automobile is known and described in Japanese Patent Application Laid-Open (JP-A) No. 7-32904. This shift lever device is provided with: a control lever that is supported so as to be able to pivot in each of a shift direction and a select direction; and a cable arm (control lever) that is coupled to an automatic gear change through a control cable and is supported so as to be able to move in the shift direction. In this shift lever device, when the shift lever is manipulated to one end of the shift lever movable range along the select direction to a drive position (D position) that is in an automatic gear change mode selection area, the shift lever moves to a manual gear change mode selection area, and it becomes possible to manipulate gear change of the automatic gear change by the manual gear change mode, and furthermore, with manipulation of the shift lever to the other end along the select direction in the manual gear change mode selection area, the shift lever moves to the D position of the automatic gear change mode selection area, and gear change manipulation by the automatic gear change mode becomes possible.

In the above described shift lever device, when the shift lever is in the state of being in the automatic gear change mode selection area, the control lever is coupled to the shift lever by an arm that is provided to the shift lever being inserted and fitted into a notch formed on the control lever, and the control lever moves in the shift direction integrated to the shift lever. In doing so, when the shift lever is manipulated by shifting from the D position to another shift position (neutral position (N position), reverse position (R position), parking position (P position) and the like), manipulating force is transmitted from the shift lever via the control cable to the automatic gear change, and due to the manipulating force the automatic gear change reaches a gear change state that corresponds to the selected shift position of the shift lever. Also, when the shift lever is moved from the D position in the automatic gear change mode selection area to the manual gear change mode selection area, the arm of the shift lever comes out from the notch in the control lever, and the coupled state of the control lever with the shift lever is released.

### SUMMARY

A shift lever device according to a first exemplary embodiment of the present invention includes a shift lever, a control lever, a lever member, a striker member, and a stopper member. The shift lever is moveable along a first manipulation direction and a second manipulation direction that are substantially orthogonal to each other. The shift lever is moveable to a desired shift position in an automatic gear change mode selection area by manipulation along the first manipulation direction and the second manipulation direction. Also, when the shift lever is manipulated toward one end side along the second manipulation direction from a particular shift position in the automatic gear change mode selection area, the shift lever moves from the automatic gear change mode selection area to a manual gear change mode selection area, and when the shift lever is manipulated from the manual gear change mode selection area toward the other end side in the second manipulation direction, the shift lever returns to the automatic gear change mode selection area from the manual gear change mode selection area. The control lever is moveable in the first manipulation direction and is coupled to a gear change device, and also when the shift lever is in the automatic gear change mode selection area, the control lever becomes coupled integrally to the shift lever and moves in the first manipulation direction, and when the shift lever moves from the automatic gear change mode selection area to the manual gear change mode selection area, the coupled state of the control lever to the shift lever is released. The lever member is coupled to the control lever so as to move integrally with the control lever along the first manipulation direction. The striker member is supported by the lever member so as to be moveable between a predetermined released position and a predetermined constrained position. The striker member also engages with the shift lever, and when the shift lever moves from the automatic gear change mode selection area to the manual gear change mode selection area, the striker member moves from the released position to the constrained position, and when the shift lever returns to the automatic gear change mode selection area from the manual gear change mode selection area, the striker member returns to the released position from the constrained position. The stopper member prevents movement along the first manipulation direction of the lever member when the striker member is in the constrained position, and the stopper member permits movement along the first manipulation direction of the lever member when the striker member is returned to the released position.

### BRIEF DESCRIPTION OF THE DRAWINGS

Exemplary embodiments of the present invention will be described in detail based on the following figures, wherein:

FIG. 1 is an exploded perspective diagram showing the overall configuration of a shift lever device according to a first exemplary embodiment of the present invention;

FIG. 2 is a plan view showing the face side of the lever guide shown in FIG. 1;

FIG. 3 is a front view showing relevant portions of the shift lever device according to the first exemplary embodiment of the present invention;

FIG. 4 is a perspective view of in the shift lever device shown in FIG. 3, showing a state in which the shift lever is in position D in an automatic gear change area;

FIG. 5 is a perspective view of relevant portions in the shift lever device shown in FIG. 3, showing a state in which the shift lever is in the manual change gear change area;

FIG. 6 is a perspective view of relevant portions in a shift lever device according to a second exemplary embodiment of the present invention, showing a state in which the shift lever is in position D in the automatic gear change area;

FIG. 7 is a perspective view of relevant portions in the shift lever device shown in FIG. 6, showing a state in which the shift lever is in the manual gear change area;

FIG. 8 is a perspective view of relevant portions in a shift lever device according to a third exemplary embodiment of the present invention, showing a state in which the shift lever is in the automatic gear change area position D; and

FIG. 9 is a perspective view of relevant portions in the shift lever device shown in FIG. 8, showing a state in which the shift lever is in the manual area.

### DETAILED DESCRIPTION

Explanation will now be given of an example of a shift lever device according to an exemplary embodiment of the present invention, with reference to the drawings.

### First Exemplary Embodiment

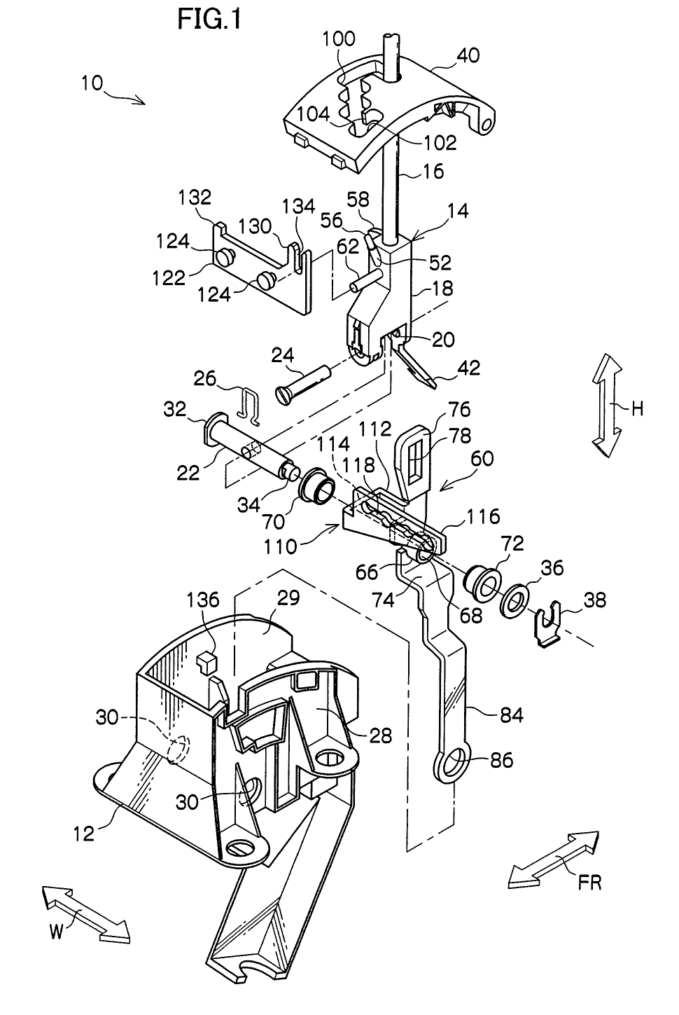

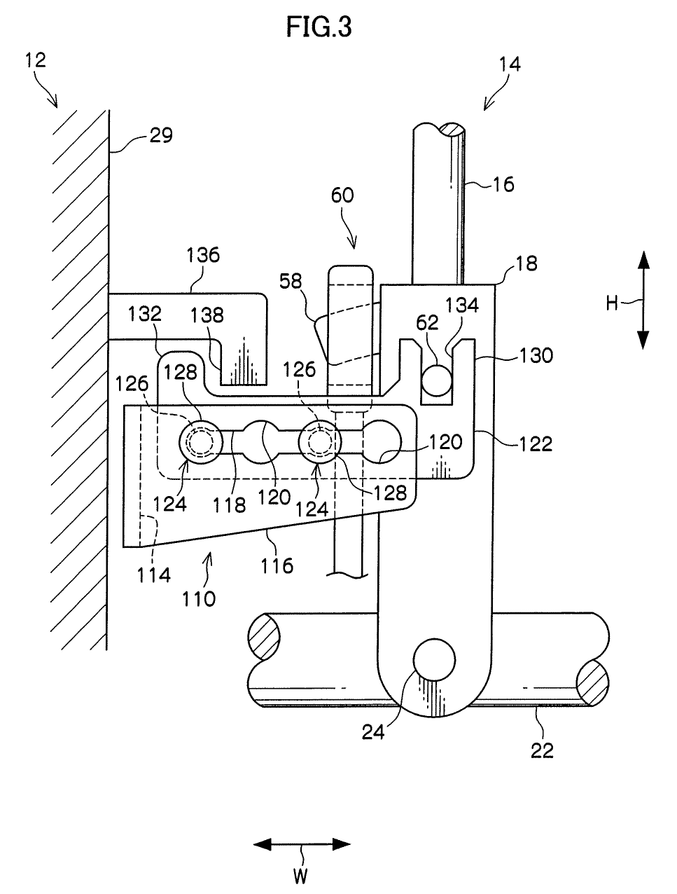

FIG. 1 shows the overall configuration of a shift lever device 10 according to a first exemplary embodiment of the present invention, shown in exploded perspective view. Also FIG. 3 to FIG. 5 show the configuration of relevant portions of the shift lever device 10 shown in FIG. 1. It should be noted that shift lever device 10 is configured as a gate shift lever device with which manual gear change operations may be carried out, with selectable gear change modes of a manual gear change mode and an automatic gear change mode.

The shift lever device 10, as shown in FIG. 1, is provided with a housing case 12, which is a box shape that is fastened and fixed by bolts or the like to the lower side of a vehicle body frame. There is a shift lever 14 disposed at a central portion inside the housing case 12. The shift lever 14 is provided with a round bar shaped lever rod 16 and a support member 18 that covers the lower end portion side of the lever rod 16. There is a non illustrated shift knob fixed to an upper end portion of the lever rod 16.

The support member 18 is formed from a resin material or the like into a rectangular cross-section bar shape, and there is a notch portion 20 formed to the lower end portion thereof so as to pass through the support member 18 in the vehicle width direction (the direction of arrow W, referred to later as “width direction”) at a central portion of the support member 18 in the vehicle front-rear direction (the direction of arrow FR, referred to later as “front-rear direction”). There is a circular column shaped first support shaft 22 disposed parallel to the vehicle width direction and fitted into the notch portion 20, and the lower end portion of the support member 18 is rotatably coupled to the first support shaft 22 by a circular column shaped second support shaft 24. It should be noted that the second support shaft 24 is latched to the support member 18 by an engaging clip 26.

The first support shaft 22 is inserted through respective through holes 30 formed through a pair of side walls 28, 29 in the housing case 12, and both end portions in the axial direction of the first support shaft 22 project to the outside from the side walls 28, 29 of the housing case 12. There is a flange shaped retaining portion 32 provided at one projecting end portion in the axial direction of the first support shaft 22, and the retaining portion 32 is engaged with the edges of the through hole 30. There is a circular column shaped latching portion 34 that protrudes out from the other end portion in the axial direction of the first support shaft 22, and there is a clip 38 engaged to the latching portion 34, with a flat washer 36 located between the clip 38 and the through hole 30 and engaged to the edges of the through hole 30. The first support shaft 22 is thereby not able to move along the axial direction, and is supported by the housing case 12 so as to be rotatably about the axial direction.

In such a manner the shift lever 14 is able to be manipulated in a shift direction (first manipulation direction) about the axial direction of the first support shaft 22, and also is able to be manipulated in a select direction (second manipulation direction), which is orthogonal to the shift direction, about the axial direction of the second support shaft 24.

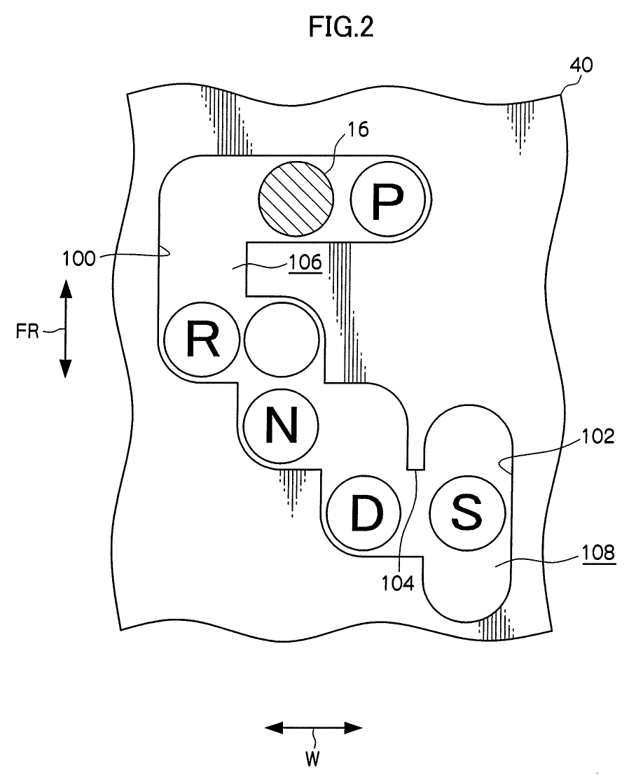

In the shift lever device 10 there is a thick plate shaped lever guide 40 provided closing off the opening at the upper end side of the housing case 12. The lever guide 40, as shown in FIG. 2, has formed therein: a first guide groove 100 that extends in a zig-zag fashion along the shift direction and the select direction; a second guide groove 102 that extends along the shift direction; and a connection guide groove 104 that connects the first guide groove 100 and the second guide groove 102. The first guide groove 100 configures an automatic gear change area 106 that is an area for selecting the automatic gear change mode, and the second guide groove 102 configures a manual gear change area 108 that is an area for selecting the manual gear change mode.

The groove width of the guide grooves 100, 102, 104 of the lever guide 40 is just slightly greater than the external diameter of the lever rod 16 of the shift lever 14. As shown in FIG. 1, the lever rod 16 of the shift lever 14 is inserted through the guide grooves 100, 102, 104. The shift lever 14 is thereby retained inside one of the first guide groove 100, the second guide groove 102 or the connection guide groove 104, and is also able to move along the first guide groove 100, the second guide groove 102, and the connection guide groove 104.

In the shift lever device 10, when the shift lever 14 is in the state of being positioned within the automatic gear change area 106 (see FIG. 2), the shift lever 14 is movable to a selected shift position (in the present exemplary embodiment these being: a parking position (P position); a reverse position (R position); a neutral position (N position); and a drive position (D position)) by manipulation so as to move along the first guide groove 100 in the shift direction or the select direction. The P position, R position, N position and D position are set so as to each be different positions in the shift direction.

The shift lever device 10 is provided with a P position detection switch, and a solenoid for locking the position of the shift lever 14 in the P position (both omitted in the figures). It is configured such that when in the state in which the shift lever 14 is detected as being positioned in the P position by the P position detection switch, the shift lever 14 is prevented from moving from the P position to the R position, unless the vehicle foot brake is operated.

In the shift lever device 10, in the state in which the shift lever 14 in the automatic gear change area 106 is positioned in a specific shift position (the D position in the present exemplary embodiment), by moving manipulation to one end of the movable range (the right side in the present exemplary embodiment) along the select direction, the shift lever 14 is moved to the second guide groove 102 (manual gear change area 108) through the connection guide groove 104 (see FIG. 2). In the manual gear change area 108, the shift lever 14 is biased to an S position that is set in a central portion along the shift direction of the second guide groove 102. The shift lever 14 is movable along the shift direction to a shift waiting position (S position), to a shift up position (+ position) and to a shift down position (− position).

In the shift lever device 10, it is configured such that, when the shift lever 14 that is in the S position of the manual gear change area 108 is moved by manipulation to the + position or the − position, as shown in FIG. 1, a switch arm 42 that protrudes out to the vehicle bottom side from the lower end portion of the support member 18 operates a control switch (omitted in the figure) that is fixed to the housing case 12, and the automatic gear change of the vehicle is thereby shifted in the manual gear change mode. Specifically, when the shift lever 14 in the S position is moved by manipulation to the + position, the automatic gear change is shifted up, and when the shift lever 14 in the S position is moved by manipulation to the − position, the automatic gear change is shifted down.

In the shift lever device 10, when the shift lever 14 in the manual gear change area 108 is in the state of being positioned in the S position, the shift lever 14 returns to the first guide groove 100 (the automatic gear change area 106), via the connection guide groove 104, by manipulation of the shift lever 14 moving the shift lever 14 in the other direction along the select direction (to the left side in the present exemplary embodiment).

As shown in FIG. 1, there is a cylindrical tube shaped holder portion 52 that is provided protruding upwards at an angle from a central portion in the length direction of the support member 18. A cylindrical column shaped restraining pin 56 is inserted inside the holder portion 52, the restraining pin 56 being able to move so as to retract or extend along the axial direction of the holder portion 52. The restraining pin 56 is continuously biased upwards (to the lever guide 40 side) by a coil spring (omitted in the figure) that is disposed at the base end side of the restraining pin 56.

The restraining pin 56 is coupled by the holder portion 52 so as to move integrally with the shift lever 14 in the shift direction and the select direction, and the leading end portion of the restraining pin 56 abuts to a sliding guide surface (omitted in the figure) that is formed on the back face of the lever guide 40. The restraining pin 56 transmits a reaction force from the sliding guide surface to the shift lever 14, through the coil spring. This reaction force acts as a retaining force when the shift lever 14 is in a state of being in the automatic gear change area 106 to stably maintain the shift lever 14 when it has reached a particular shift position (P, R, N, or D position). Also, this reaction force acts as a biasing force (resistance force or urging force) to impart a restraining feeling to an operator of the shift lever 14 when the shift lever 14 is moving between adjacent shift portions in the automatic gear change area 106.

When the shift lever 14 is in the S position of the manual gear change area 108, the reaction force of the sliding guide surface acts as a retaining force to stably maintain the shift lever 14 in the S position, and after the shift lever 14 has been moved by manipulation from the S position to a shift change position (the + position or the − position) the reaction force acts as a biasing force (return force) to return the shift lever 14 to the S position.

In the support member 18, as shown in FIG. 1 and FIG. 3, there is an engagement projection 58 that configures a clutch mechanism and that is provided projecting to one side in the vehicle width direction (to the left side of the vehicle in the present exemplary embodiment). The engagement projection 58 is provided to the top end side of the support member 18, and is formed in a substantially rectangular shape in cross-section along the vehicle front-rear direction. Furthermore, there is a round bar shaped coupling projection 62 that projects in the front-rear direction out to the rear side from the support member 18 at the bottom side of the holder portion 52. The coupling projection 62 is engaged to a striker plate 122, described later.

As shown in FIG. 1, there is a control lever 60 formed in a thin long plate shape that is disposed overall in the vehicle up-down direction (the direction of arrow H, referred to later as the “up-down direction”), and the control lever 60 is formed, for example, by bending a metal plate. There is a cylindrical tube shaped shaft receiving portion 66 fixed to the control lever 60 at a central portion in the length direction thereof. The shaft receiving portion 66 passes through the control lever 60 along the width direction. There is an insertion hole 68 formed at the inner periphery of the shaft receiving portion 66, and one end portion of the first support shaft 22 is inserted into the insertion hole 68, with a pair of bushings 70, 72 therebetween, so as to be relatively rotatable to the insertion hole 68. The control lever 60 is thereby supported by the first support shaft 22 so as to be rotatable about the central axis of the first support shaft 22.

In the control lever 60 there is a bent portion 74 formed at the side below the shaft receiving portion 66, the bent portion 74 being bent to the outside in the width direction, and also there is a cable mounting portion 84 integrally formed to the control lever 60 so as to extend out to the bottom side from the leading end portion of the bent portion 74. There is a coupling hole 86 provided pierced through at the leading end of the cable mounting portion 84, and one end portion of a control cable is fixed to the coupling hole 86 with bushings (omitted in the figure) therebetween. The other end of the control cable is coupled to the automatic gear change, and the control lever 60 is thereby coupled to the vehicle automatic gear change through the cable mounting portion 84.

There is an engagement lug 76 provided to the control lever 60 so as to correspond to the engagement projection 58 of the shift lever 14. The engagement lug 76 is formed in a substantially thin long rectangular shape in the up-down direction, when seen in side view from the outside in the vehicle width direction. There is an engagement hole 78 provided to a central portion of the engagement lug 76, pierced through in the thickness direction thereof, and engagement projection 58 of the shift lever 14 can be inserted into and removed from the engagement hole 78.

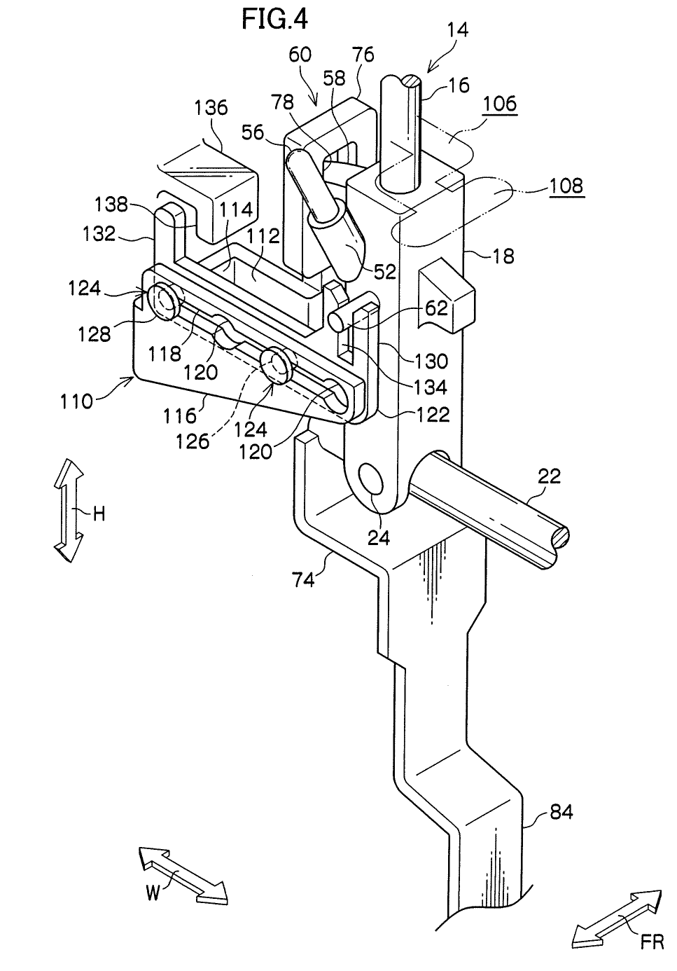

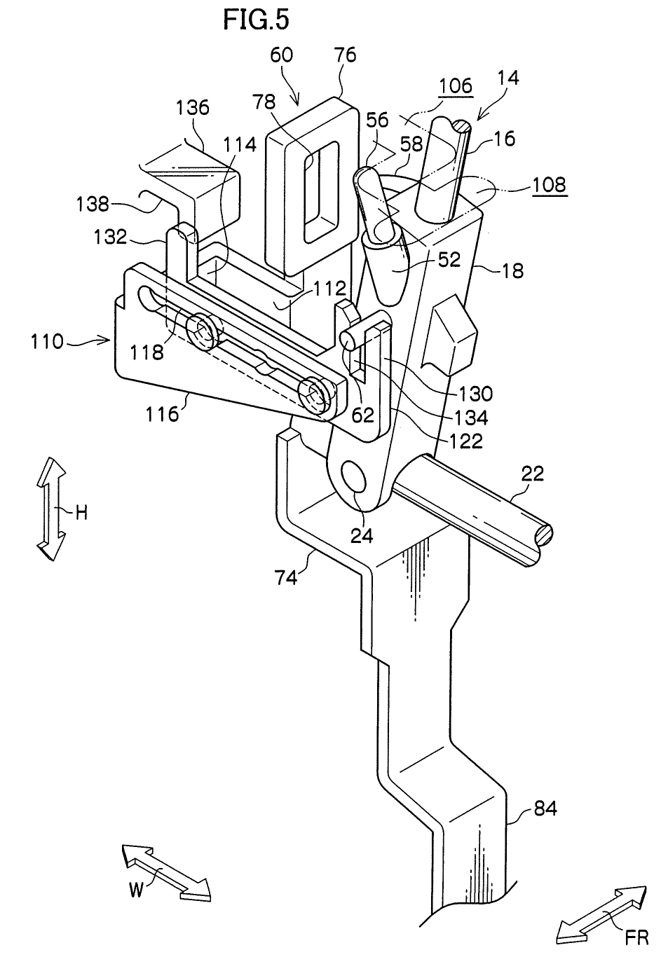

As shown in FIG. 3 and FIG. 4, when in the state in which the shift lever 14 is positioned in the automatic gear change area 106 (see FIG. 2), the engagement projection 58 of the shift lever 14 is fitted into the engagement hole 78 of the control lever 60. The shift lever 14 is thereby coupled to the control lever 60 through the engagement projection 58 and the engagement lug 76, and the shift lever 14 is integrated with the control lever 60, and is able to rotate around the central axis of the first support shaft 22. Furthermore, as shown in FIG. 5, when the shift lever 14 is in the state of being positioned in the manual gear change area 108 (see FIG. 2), the engagement projection 58 is removed from the engagement hole 78. The coupled state of the shift lever 14 with the control lever 60 is thereby released, and the shift lever 14 becomes independent of the control lever 60, and becomes able to rotate around the central axis of the first support shaft 22.

Therefore, in the shift lever device 10, when the shift lever 14 is manipulated in the shift direction from the state of being positioned in the automatic gear change area 106 (see FIG. 2), the shift lever 14 is coupled to the control lever 60 through the engagement projection 58 and the engagement lug 76, the shift lever 14 and the control lever 60 become integrated together, and rotate about the central axis of the first support shaft 22. Thereby, the automatic gear change is shift manipulated through the cable mounting portion 84 of the control lever 60. That is to say, selection of plural automatic gear change modes of the automatic gear change is coupled to movements of the shift lever 14 to the desired shift position (in the present exemplary embodiment one of the P position, R position, N position or the D position).

Furthermore, in the state in which the shift lever 14 is positioned in the D position, when the shift lever 14 is moved by manipulation to one end side (right side) of its movable range along the select direction so that the shift lever 14 is moved to the manual gear change area 108, then, as shown in FIG. 5, the engagement projection 58 is removed from the engagement hole 78 of the engagement lug 76, and the coupled state of the shift lever 14 with the control lever 60 is released. Thereby, while the control lever 60 is maintained in the D position, the shift lever 14 in the S position is movably by manipulation along the shift direction to the + position or the − position. When, in the shift lever device 10, the shift lever 14 is moved by manipulation along the shift direction to the + position or the − position, the manual gear change control switch is operated, and the automatic gear change is shifted up or shifted down in the manual gear change mode.

As shown in FIG. 1, there is a support lever 110 provided integrally to the control lever 60 between the shaft receiving portion 66 and the engagement lug 76. The support lever 110 is formed in a thin long plate shape that bends around in a substantially U-shape when seen in plan view, and a base end portion of the support lever 110 is connected to a portion at the rear side in the front-rear direction of the control lever 60. In the support lever 110 there is a base end side stay portion 112 formed extending out in the width direction to the housing case 12 side wall 29 side from a portion at the edge of the control lever 60, and there is also an intermediate stay portion 114 formed integrally to the leading end portion of the base end side stay portion 112, and extending out therefrom to the rear side in the front-rear direction.

In the support lever 110 there is a support plate portion 116 formed integrally to the leading end portion of the intermediate stay portion 114, and extending out in the width direction therefrom toward the housing case 12 side wall 28. As shown in FIG. 3, the support plate portion 116 is formed to be longer in the width direction than the base end side stay portion 112, and the leading end side of the support plate portion 116 protrudes out relative to the control lever 60 toward one end in the width direction. There is a guide groove 118 formed extending along the width direction at a portion at the top side of the support plate portion 116. There are insertion portions 120 formed at a portion at one end in the width direction (see FIG. 3, an end portion at the right side) of the guide groove 118 and at an intermediate portion thereof, respectively, and each of the insertion portions 120 is a local widening in the groove width of the guide groove 118. The insertion portions 120 are formed as circular apertures with internal diameters thereof that are larger in the up-down direction than the width of the guide groove 118.

The shift lever device 10 is provided with the striker plate 122 that is coupled to the support member 18 through the coupling projection 62. The striker plate 122, as shown in FIG. 1, is formed in a substantially rectangular shaped plate with a length thereof in the width direction, and a pair of guide pins 124 is fixed to a rear face portion that is at the rear side in the front-rear direction of the striker plate 122. The pair of guide pins 124 has practically equivalent pitch therebetween along the width direction to the pitch of the pair of insertion portions 120 in the support plate portion 116. There are round bar shaped shaft receiving portions 126 formed at the base end side of the guide pins 124, and there are also circular plate shaped head portions 128 integrally formed at the leading end portions of the shaft receiving portions 126, with external diameters that are larger than that of the shaft receiving portions 126.

The external diameter of the shaft receiving portions 126 is just slightly smaller than the groove width of the guide groove 118 (except for at the insertion portions 120), and the external diameter of the head portions 128 is larger in diameter than the groove width of the guide groove 118, but slightly smaller than the internal diameter of the insertion portions 120.

The striker plate 122 is coupled to the support plate portion 116 through the pair of guide pins 124. Specifically, when coupling the striker plate 122 to the support plate portion 116, after each of the pair of guide pins 124 has been inserted into the guide groove 118 through the respective one of the pair of insertion portions 120, the striker plate 122 is slid toward the other end along the width direction, and the pair of guide pins 124 are separated from the insertion portions 120. In such a state, the guide pins 124 are prevented from coming out from the guide groove 118 by the head portions 128, and also the striker plate 122 is supported, through the pair of guide pins 124, by the support plate portion 116 of the support lever 110 so as to be able to slide along the guide groove 118. In this state, the striker plate 122 is supported so as to be able to slide along the width direction between a released position (see FIG. 3 and FIG. 4) and a constrained position (see FIG. 5).

As shown in FIG. 1, there is a coupling lug 130 formed integrally to the striker plate 122 and extending out to the top thereof at a portion at one end in the width direction, and also there is a constraining lug 132 integrally formed at a portion at the other end of the striker plate 122 and extending out to the top thereof. There is a notch portion 134 formed as a narrow long U-shape extending in the up-down direction, and the top end of the notch portion 134 is open to the top edge face of the coupling lug 130. In the shift lever device 10, the coupling projection 62 of the support member 18 is inserted into the notch portion 134 and fitted therein in the vicinity of the bottom end thereof. By so doing, when the shift lever 14 moves along the select direction, the striker plate 122 is integrated to the shift lever 14 and slides in the width direction.

When this happens, the shift lever 14 that is moved by manipulation in the select direction undergoes rotational movement with the second support shaft 24 at the center, and so the coupling projection 62 moves in the width direction, and also moves in the up-down direction, however, by the coupling projection 62 sliding in the length direction (up-down direction) within the notch portion 134, coupled to the shift lever 14 moved by manipulation in the select direction, the striker plate 122 only moves in the width direction.

Furthermore, the length of the coupling projection 62 is set to be longer than the displacement amount of the stroke along the shift direction of the coupling projection 62 when the shift lever 14 is moved between the + position and the − position in the manual gear change area 108. Thereby, when the shift lever 14 has moved in its stroke between the + position and the − position in the manual gear change area 108, the coupling projection 62 remains in an inserted state within the notch portion 134 and slides (moves in its stroke) along the shift direction, thereby maintaining the coupled state between the striker plate 122 and the shift lever 14.

In the shift lever device 10, when the shift lever 14 moves from the D position in the automatic gear change area 106 along the select direction to the manual gear change area 108, the striker plate 122, coupled to this movement, slides from the released position shown in FIG. 4, to the constrained position shown in FIG. 5. Also, when the shift lever 14 returns to the D position of the automatic gear change area 106 along the select direction from the manual gear change area 108, the striker plate 122, coupled to this movement, returns from the constrained position to the released position.

In the housing case 12, as shown in FIG. 1, there is a stopper member 136 integrally formed in a block shape protruding out to the inside of the housing case 12 from the side wall 29 that is at the other side in the width direction. The stopper member 136 is formed in a substantially rectangular shape when seen in plan view, and is disposed to correspond in the up-down direction and the front-rear direction with the constraining lug 132 of the striker plate 122. The stopper member 136 is formed as an L-shape when seen in front view from the vehicle front-rear direction, and there is a notch portion 138 formed so as to pierce through, in the front-rear direction, at the bottom side of the base end portion of the stopper member 136, the notch portion 138 being formed with a rectangular cross-section that is open to the bottom face of the stopper member 136 (see FIG. 3).

In the shift lever device 10, as shown in FIG. 3 and FIG. 4, when the striker plate 122 is in the released position, the constraining lug 132 of the striker plate 122 directly faces the notch portion 138 of the stopper member 136. Thereby, since the constraining lug 132 of the striker plate 122 is able to move along the shift direction through the inside of the notch portion 138, the striker plate 122, and also the shift lever 14 that has been coupled to the striker plate 122 through the support lever 110, is able to move along the shift direction.

In the shift lever device 10, as shown in FIG. 5, when the striker plate 122 slides to the constrained position, the constraining lug 132 of the striker plate 122 directly faces the leading end side of the notch portion 138 in the stopper member 136. The striker plate 122 is thereby prevented from moving from the D position to the front side (the P position side) along the shift direction, and hence the striker plate 122, and the shift lever 14 that has been coupled to the striker plate 122 through the support lever 110, is prevented from moving to the front side along the shift direction.

(Operation of the Exemplary Embodiment)

Next, explanation will be given of the operation of the shift lever device 10 according to the first exemplary embodiment of the present exemplary embodiment that has been configured as described above.

In the shift lever device 10, when the shift lever 14 moves from the D position in the automatic gear change area 106 to the manual gear change area 108, coupled to this movement, the striker plate 122 slides along the width direction from the released position (shown in FIG. 4) to the constrained position (shown in FIG. 5), and thereby the stopper member 136 prevents the striker plate 122 that is in the constrained position from moving along the shift direction, and also prevents the support lever 110 and the shift lever 14, which have been integrated to the striker plate 122 and are moving in the shift direction, from moving along the shift direction.

Therefore, according to the shift lever device 10, when the shift lever 14 moves from the D position to the manual gear change area 108, the control lever 60 that is in the D position in the automatic gear change area 106 is prevented from moving along the shift direction, and even though the coupled state of the shift lever 14 with the control lever 60 is released, the control lever 60 may be prevented from moving along the shift direction from the D position.

Also, in the shift lever device 10, when the shift lever 14 returns from manual gear change area 108 to the D position of the automatic gear change area 106, coupled to this movement, the striker plate 122 is returned from the constrained position to the released position, and thereby the stopper member 136 makes the notch portion 138 face directly to the constraining lug 132, and thereby permits movement of the striker plate 122 in the shift direction.

Therefore, according to the shift lever device 10, the control lever 60 that has been coupled to the striker plate 122 through the support lever 110 is able to move along the shift direction, and also since the control lever 60 is coupled to the shift lever 14 that has been returned to the automatic gear change area 106, the control lever 60 becomes in a state of being integrated to the shift lever 14 and moves along the shift direction.

### Second Exemplary Embodiment

(Exemplary Embodiment Configuration)

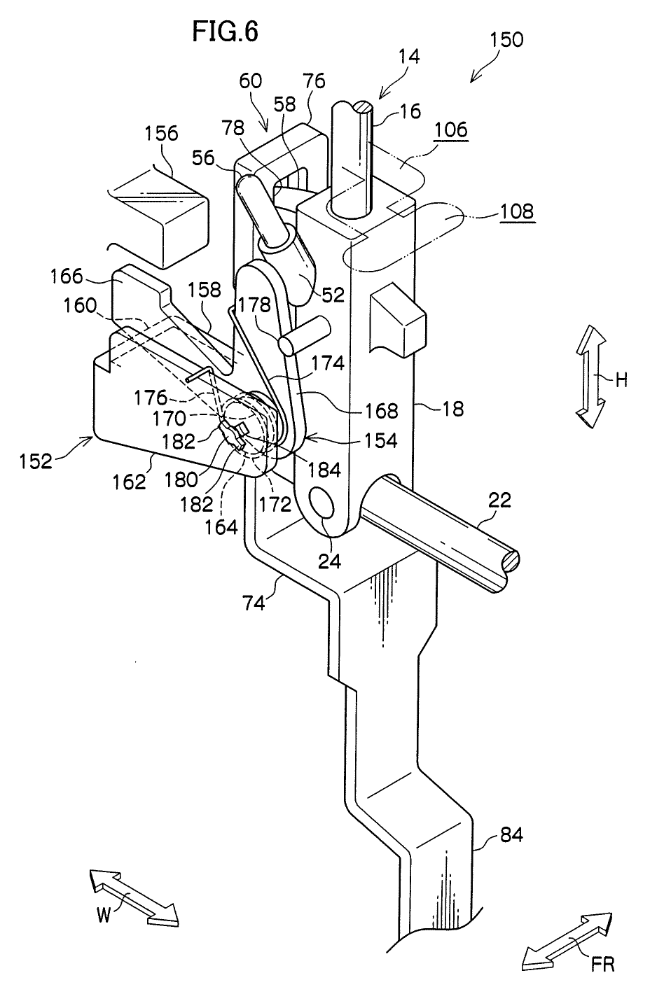

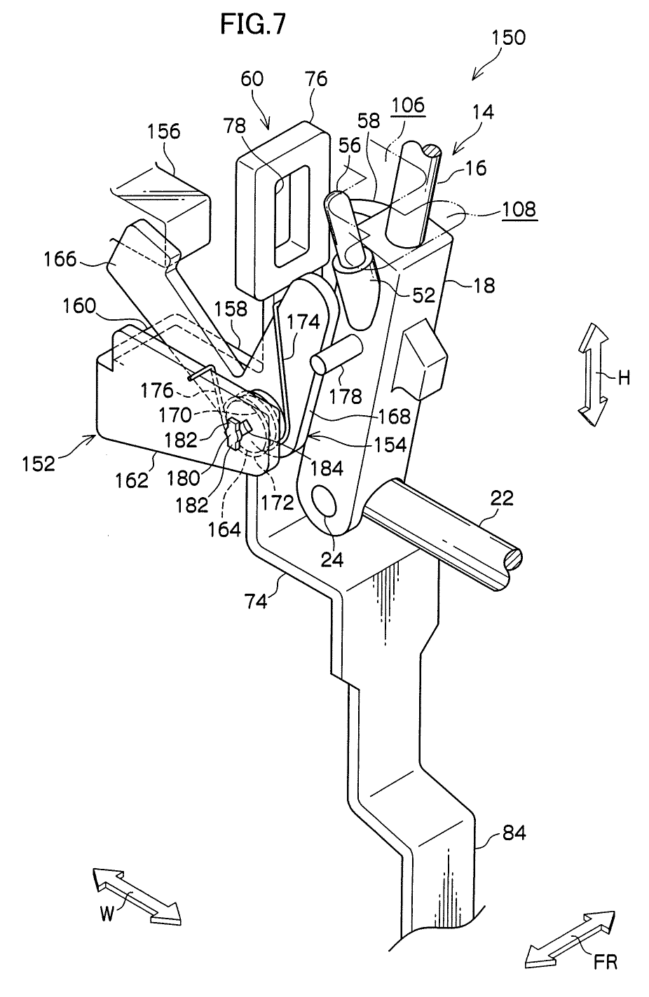

The configuration of relevant portions of a shift lever device 150 according to a second exemplary embodiment of the present invention are shown in FIG. 6 and FIG. 7. It should be noted that in the shift lever device 150 according to the present exemplary embodiment, the portions thereof that are similar to those of the shift lever device 10 of the first exemplary embodiment are allocated the same reference numerals and explanation will be omitted.

Also, in the configuration of the shift lever device 150 of the present exemplary embodiment, the support lever 110, striker plate 122 and stopper member 136 of the configuration of the shift lever device 10 shown in FIG. 1 are omitted, and instead of these members, a support lever 152, a striker plate 154 and a stopper member 156 are provided. This should be borne in mind when sometimes below it is necessary to refer to FIG. 1 in the explanation of the shift lever device 150.

As shown in FIG. 6, the support lever 152 is provided integrally to the control lever 60 between the shaft receiving portion 66 and the engagement lug 76. The support lever 152 is formed in a thin long plate shape that bends around substantially in a U-shape when seen in plan view, and a base end portion of the support lever 152 is connected to a portion at the edge at the rear side in the front-rear direction of the control lever 60. In the support lever 152 there is a base end side stay portion 158 formed extending out in the width direction toward the side wall 29 of the housing case 12 (see FIG. 1) from a portion at the edge of the control lever 60, and there is also an intermediate stay portion 160 formed integrally to the leading end portion of the base end side stay portion 158, and extending out therefrom to the rear side in the front-rear direction.

In the support lever 152 there is a support plate portion 162 formed integrally to the leading end portion of the intermediate stay portion 160, and extending out therefrom in the width direction toward the housing case 12 side wall 28 (see FIG. 1). Also, the shift lever device 150 is provided with the striker plate 154 that is coupled, through a coupling shaft 164, to the support plate portion 162 so as to be able to swing. The striker plate 154 is formed in a narrow long plate shape, and the length direction thereof is bent into substantially a V-shape.

There is a constraining lever portion 166 formed to the striker plate 154, the constraining lever portion 166 being provided so as to extend substantially parallel to the width direction at a portion at one end side of the striker plate 154 bent portion, and there is a pressing lever portion 168 provided so as to extend substantially parallel to the up-down direction at the other end of the striker plate 154. The circular bar shaped coupling shaft 164 is provided so as to protrude out to the rear side in the front-rear direction at a base end portion of the striker plate 154. There is a latching shaft 180 provided coaxially at the leading end face of the coupling shaft 164, protruding out in the axial direction. There is a pair of latching lugs 182 provided to the leading end of the latching shaft 180, extending out in radial direction to opposite sides therefrom.

In the support lever 152 there is a latching hole 184 provided so as to pierce, in the front-rear direction, through a leading end portion of the support plate portion 162, and the cross-sectional shape of the latching hole 184 is shaped to correspond to the projection of the latching shaft 180 and the pair of latching lugs 182 along the axial direction. The latching shaft 180 and the pair of latching lugs 182 are able to pass through the latching hole 184 by maintaining the striker plate 154 at a predetermined angle (tilt) that is outside of the operational range in the state when the striker plate is mounted to the support lever 152.

Therefore, when mounting the striker plate 154 to the support lever 152, the latching shaft 180 and the pair of latching lugs 182 are inserted through the latching hole 184, and after the latching shaft 180 and the pair of latching lugs 182 protrude out to the outside of the striker plate 154, by tilting the striker plate 154 from the angle that is outside of the operational range to an angle that is within the operational range, the striker plate 154 is coupled to the support lever 152 so as to be able to swing. In this position, the striker plate 154 is supported so as to be able to swing in a rotational direction about the latching shaft 180 as the center, between a predetermined released position (see FIG. 6) and constrained position (see FIG. 7).

The shift lever device 150 is provided with a torsional coil spring 172 that fits over the outer peripheral surface side of the coupling shaft 164, and that is mounted between the support plate portion 162 and the striker plate 154. Each end of the torsional coil spring 172 is formed into respective straight line shaped arm portions 174, 176, and the leading end portions of each of the arm portions 174, 176, which are respectively formed into L-shapes, are latched to the pressing lever portion 168 and the support plate portion 162. The striker plate 154 is thereby constantly biased by the torsional coil spring 172 in a clock-wise direction when viewed from the vehicle rear direction.

There is a round bar shaped pressing protrusion 178 formed to the bottom side of the holder portion 52 and protruding along the front-rear direction. The pressing protrusion 178 presses against the side face of the pressing lever portion 168 that has been biased in the clock-wise direction by the torsional coil spring 172, and restricts rotational movement of the striker plate 154 in the clock-wise direction. The length of the pressing protrusion 178 is made longer than the displacement amount of the pressing protrusion 178 along the shift direction when the shift lever 14 in the manual gear change area 108 moves a stroke between the + position and the − position. Due to this, even if the shift lever 14 in the manual gear change area 108 moves a stroke between the + position and the − position, the pressing protrusion 178 is constantly maintained in pressing abutment to the pressing lever portion 168.

In the shift lever device 150, when the shift lever 14 moves along the select direction from the D position in the automatic gear change area 106 to the manual gear change area 108, while the striker plate 154 presses the pressing lever portion 168 against the pressing protrusion 178 due to the biasing force of the torsional coil spring 172, the striker plate 154 swings from the released position shown in FIG. 6 to the constrained position shown in FIG. 7. Also, when the shift lever 14 returns along the select direction to the D position in the automatic gear change area 106 from the manual gear change area 108, the striker plate 154 swings from the constrained position to the released position against the torsional coil spring 172, which is due to the pressing force from the pressing protrusion 178.

As shown in FIG. 6, in the housing case 12 (see FIG. 1), the block shaped stopper member 156 is formed integrally to, and protruding out from, an inside portion at the other end in the width direction of the housing case 12, at the side wall 29. The stopper member 156 is disposed so as to correspond in the up-down direction and the front-rear direction to the constraining lever portion 166 of the striker plate 154.

In the shift lever device 150, as shown in FIG. 6, when the striker plate 154 is in the released position, the leading end portion of the constraining lever portion 166 is maintained in a position that is, relative to the stopper member 156, separated and below. Due to this, since the constraining lever portion 166 of the striker plate 154 is movable in the shift direction past the bottom side of the stopper member 156, the shift lever 14 that has been coupled to the striker plate 154 through the support lever 152 is also movable along the shift direction.

Furthermore, in the shift lever device 150, as shown in FIG. 7, when the striker plate 154 swings to the constrained position, the leading end portion of the constraining lever portion 166 directly faces the stopper member 156. Thereby, since movement of the striker plate 154 along the shift direction from the D position to the front side (P position side) is prevented by the stopper member 156, the striker plate 154, and also a bottom portion of the shift lever 14 that has been coupled to the striker plate 154 through the support lever 152, are prevented from moving along the shift direction to the front side.

(Operation of the Exemplary Embodiment)

Next, explanation will be given of the operation of the shift lever device 150 configured as described above according to the second exemplary embodiment of the present exemplary embodiment.

In the shift lever device 150, when the shift lever 14 moves from the D position that is in the automatic gear change area 106 to the manual gear change area 108, coupled with this movement, the striker plate 154 swings about the coupling shaft 164 as the center from the released position (shown in FIG. 6) to the constrained position (shown in FIG. 7). Due to this, the stopper member 156 which is in the constrained position prevents movement of the striker plate 154 along the shift direction, and also movement of the support lever 152, which has been integrated to the striker plate 154 and is moving in the shift direction, along the shift direction is prevented.

Therefore, according to the shift lever device 150, when the shift lever 14 moves from the D position to the manual gear change area 108, since the movement of the control lever 60 that is in the D position in the automatic gear change area 106 along the shift direction is also prevented, through the support lever 152, even if the coupled state between the shift lever 14 and the control lever 60 is released, the control lever 60 may be prevented from moving along the shift direction from the D position.

Furthermore, in the shift lever device 150, when the shift lever 14 returns to the D position of the automatic gear change area 106 from the manual gear change area 108, coupled to this movement, the striker plate 154 swings from the constrained position to the released position, and thereby the stopper member 156 is separated from the striker plate 154 in the up-down direction and the striker plate 154 is permitted to move along the shift direction.

Thereby, according to the shift lever device 150, the control lever 60 that has been coupled to the striker plate 154 through the support lever 152 is able to move along the shift direction, and also since the control lever 60 is coupled to the shift lever 14 that has returned to the automatic gear change area 106, the control lever 60 is integrated to the shift lever 14 and in a state for moving along the shift direction.

### Third Exemplary Embodiment

(Configuration of the Exemplary Embodiment)

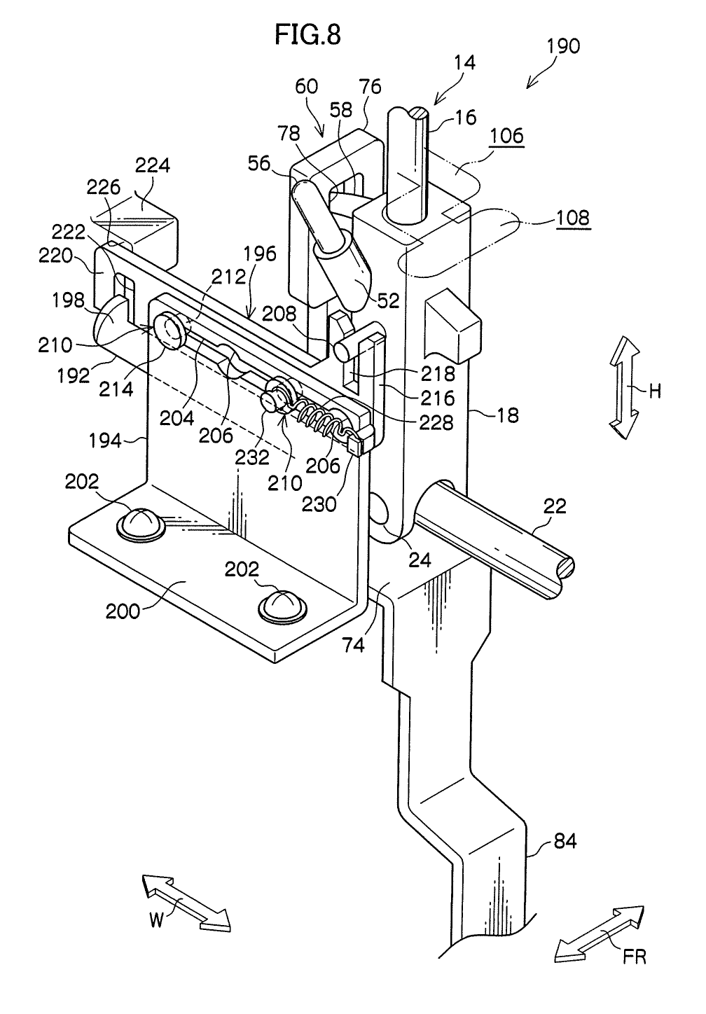

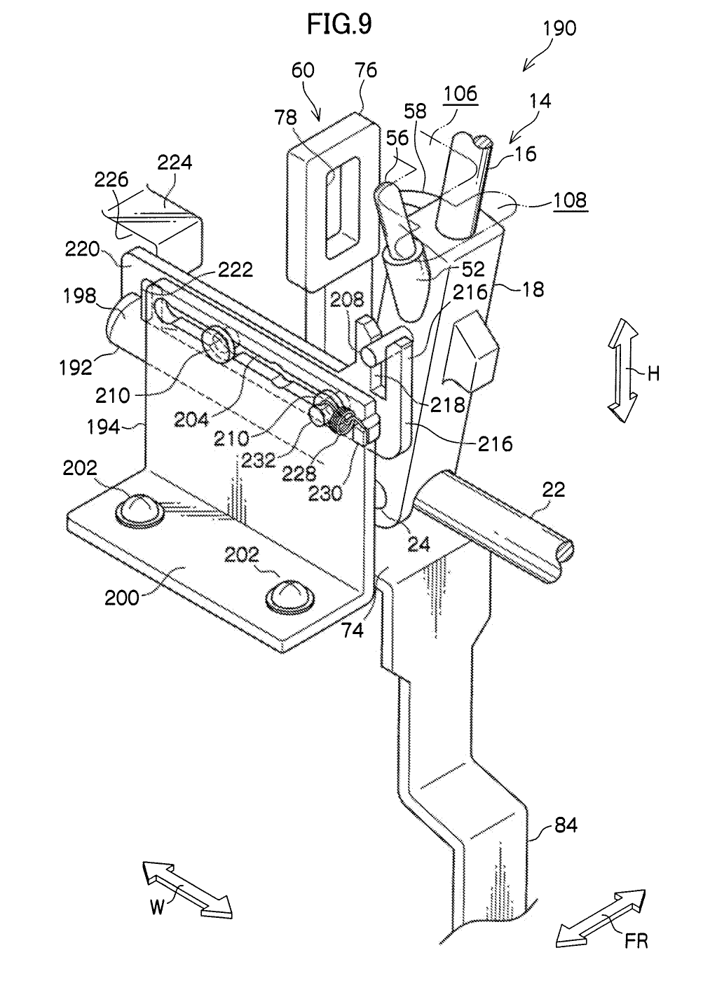

Relevant portions of the configuration of a shift lever device 190 according to a third exemplary embodiment of the present invention are shown in FIG. 8 and FIG. 9. It should be noted that in the shift lever device 190, those elements thereof that are similar to those of shift lever device 10 are allocated the same reference numerals and explanation thereof is omitted.

Furthermore, in configuration of the shift lever device 190 according to the present exemplary embodiment, the support lever 110, the striker plate 122, and the stopper member 136 of the configuration of the shift lever device 10 shown in FIG. 1 are omitted, and in place of these members a coupling lever 192, a bracket plate 194, and a stopper member 196 are provided. This should be borne in mind when sometimes below it is necessary to refer to FIG. 1 in the explanation of the shift lever device 190.

As shown in FIG. 8, the coupling lever 192 is formed integrally to the control lever 60 between the shaft receiving portion 66 and the engagement lug 76 (see FIG. 1) and extending to the vehicle rear side. The coupling lever 192 is formed in a narrow long plate shape and provided sloping such that there is an upward slope on progression from the base end side toward the leading end side. There is a substantially vane-shaped abutment portion 198 formed to the leading end portion of the coupling lever 192. In the shift lever device 190 the coupling lever 192 is integrated to the control lever 60 and moves in the shift direction.

In the shift lever device 190 the bracket plate 194 is provided at the rear side in the front-rear direction relative to the shift lever 14. There is a flange portion 200 provided to a bottom end portion of the bracket plate 194, the flange portion 200 bent at substantially a right angle toward the rear side in the front-rear direction. The flange portion 200 is fastened onto the bottom plate of the housing case 12 (see FIG. 1) by a pair of pins 202. There is a guide groove 204 formed toward the top end of the bracket plate 194 and extending in the width direction. There are insertion portions 206 formed at a portion at one end in the width direction (see FIG. 8, an end portion at the right side) of the guide groove 204 and at an intermediate portion thereof, respectively, and each of the insertion portions 206 is a local widening in the groove width of the guide groove 204. The insertion portions 206 are formed as circular apertures with internal diameters thereof that are larger than the width in the up-down direction of the guide groove 204.

As shown in FIG. 8, a round bar shaped coupling protrusion 208 is formed to the support member 18 at the bottom side of the holder portion 52 and projecting out to the rear side along the front-rear direction. The shift lever device 190 is provided with the stopper member 196, coupling the shift lever device 190 through the coupling protrusion 208 to the shift lever 14 (support member 18). The stopper member 196 is formed in a substantially rectangular plate shape with the length direction thereof in the width direction, and there is a pair of guide pins 210 fixed to the stopper member 196 at a portion at the back face thereof at the rear side thereof in the front-rear direction. The pitch in the width direction of the pair of guide pins 210 is substantially equivalent to the pitch of the pair of insertion portions 206 in the bracket plate 194. There are round bar shaped shaft portions 212 formed at the base end side of the guide pins 210, and there are also circular plate shaped head portions 214 formed integrally to the leading end portions of the shaft portions 212, with external diameters greater than those of the shaft portions 212.

The external diameter of the shaft portions 212 of the guide pins 210 is just slightly smaller than the groove width of the guide groove 204 (excluding at the insertion portions 206), and the external diameter of the head portions 214 is of a larger diameter than the width of the guide groove 204, but slightly smaller in diameter than the internal diameter of the insertion portions 206.

The stopper member 196 is coupled to the bracket plate 194 through the pair of guide pins 210. Specifically, when coupling the stopper member 196 to the bracket plate 194, after inserting each of the pair of guide pins 210 through the respective insertion portion 206 into the guide groove 204, the stopper member 196 is slid along the width direction toward the other end, and the guide pins 210 are thereby separated from the respective insertion portion 206. In this state, the pair of guide pins 210 is prevented from coming out of the guide groove 204 by the head portions 214, and also the stopper member 196 is supported, through the pair of guide pins 210, by the bracket plate 194 so as to be able to slide along the guide groove 204. In this state, the stopper member 196 is supported so as to be able to slide along the width direction between predetermined released position (see FIG. 8) and constrained position (see FIG. 9).

There is a coil spring 228 provided in the shift lever device 190, the coil spring 228 resiliently coupling the stopper member 196 and the bracket plate 194. One end portion of the coil spring 228 is latched to a latching hook 230 formed at one end portion of the bracket plate 194, and also the other end portion of the coil spring 228 is latched onto a latching protrusion 232 that projects out from the head portion 214 of the guide pin 210 that is at one end side of the bracket plate 194.

There is a coupling lug 216 formed integrally to the stopper member 196, extending toward the top from a portion at one end in the width direction of the stopper member 196. There is a thin long U-shaped notch portion 218 formed to the coupling lug 216 and extending in the up-down direction, and at the top end of the notch portion 218 there is an opening to the top end face of the coupling lug 216. The coupling protrusion 208 of the support member 18 is inserted into the notch portion 218 and fits at the vicinity of the bottom end thereof. Thereby, when the shift lever 14 moved along the select direction, the stopper member 196 is integrated to the shift lever 14 and slides along the width direction.

At such a time, since the shift lever 14, moved by manipulation in the select direction, undertakes a rotational movement about the first support shaft 22 as the center, when the coupling protrusion 208 moves in the width direction and also moves in the up-down direction, coupled to the movement by manipulation of the shift lever 14 in the select direction, the stopper member 196 only slides in the select direction, due to the coupling protrusion 208 sliding along the length direction (up-down direction) within the notch portion 218.

The length of the coupling protrusion 208 is longer than the displacement amount of the coupling protrusion 208 in the shift direction when the shift lever 14 in the manual gear change area 108 has moved by a stroke from the + position to the − position. Thereby, when the shift lever 14 in the manual gear change area 108 moves by a stroke between the + position and the − position, the coupling protrusion 208 remains in the state of being inserted into the notch portion 218, and by sliding along the shift direction (moving by a stroke) the coupled relationship between the stopper member 196 and the shift lever 14 is maintained.

In the shift lever device 190, when the shift lever 14 moves along the select direction from the D position in the automatic gear change area 106 to the manual gear change area 108, coupled to this movement, the stopper member 196 slides from the released position shown in FIG. 8 to the constrained position shown in FIG. 9. When this happens, the coil spring 228 becomes in a compressed state. Furthermore, in the shift lever device 190, when the shift lever 14 returns to the D position in the automatic gear change area 106 by moving along the select direction from the manual gear change area 108, coupled to this movement, the stopper member 196 is returned to the released position with certainty, due to the biasing force of the compressed state of the coil spring 228.

The stopper member 196 has a constraining portion 220 at the other end portion in the width direction thereof, corresponding to the abutment portion 198 of the coupling lever 192. There is a thin long notch portion 222 formed in the up-down direction to the base end side (coupling lug 216 side) of the constraining portion 220, the notch portion 222 passing through the constraining portion 220 in the front-rear direction, with an opening to the bottom end face of the constraining portion 220.

In the shift lever device 190, as shown in FIG. 8, when the stopper member 196 is in the released position, the notch portion 222 of the stopper member 196 directly faces the abutment portion 198 of the coupling lever 192. The abutment portion 198 of the coupling lever 192 is thereby able to move in the shift direction along the inside of the notch portion 222, and hence the shift lever 14 that has been coupled to the coupling lever 192 is also able to move along the shift direction.

Furthermore, in the shift lever device 190, as shown in FIG. 9, when the stopper member 196 slides to the constrained position, the leading end side of the constraining portion 220 of the stopper member 196 directly faces the abutment portion 198 of the coupling lever 192. Since movement of the coupling lever 192 is thereby prevented from the D position to the front side (P position side) along the shift direction, the shift lever 14 that has been coupled to the coupling lever 192 is prevented from moving to the front side along the shift direction.

As shown in FIG. 8, in the housing case 12 (see FIG. 1), at the other end side in the width direction there is a block shaped support member 224 formed integrally to a portion on the side of the side wall 29 and projecting to the inside of the housing case 12. The rear end face to the rear side in the front-rear direction of the support member 224 is a support face 226, and the support face 226 is formed in a flat plane shape that is perpendicular to the front-rear direction. The support member 224 abuts, so as to be able to slide, the support face 226 against the back face side of the constraining portion 220. Thereby, when the abutment portion 198 of the shift lever device 190 abuts the surface of the constraining portion 220 in the constrained position, the abutment portion 198 is supported from the back face side by the support member 224, and deformation (mainly mending deformation) of the constraining portion 220 and the stopper member 196 by the pressing force from the coupling lever 192 is effectively prevented.

### Operation of the Exemplary Embodiment

Next, explanation will be given of the shift lever device 190 configured as described above according to the third exemplary embodiment of the present invention.

In the shift lever device 190 according to the present exemplary embodiment, when the shift lever 14 moves from the D position in the automatic gear change area 106 to the manual gear change area 108, coupled to this movement, the stopper member 196 slides along the select direction from the released position to the constrained position, and thereby the constraining portion 220 that has been formed integrally to the stopper member 196, prevents, through the coupling lever 192, the control lever 60 that is in the D position from moving along the shift direction.

Therefore, according to the shift lever device 190, when the shift lever 14 is moved by manipulation from the automatic gear change area 106 to the manual gear change area 108, the control lever 60 that is in the D position in the automatic gear change area 106 is prevented from moving along the shift direction, and hence even when the coupled state of the shift lever 14 with the control lever 60 is released, and the control lever 60 is prevented from moving from the D position.

Furthermore, in the shift lever device 190, when the shift lever 14 returns to the D position of the automatic gear change area 106 from the manual gear change area 108, coupled to this movement, the stopper member 196 slides from the constrained position to the released position, and thereby the notch portion 222 of the constraining portion 220 that has been formed integrally to the stopper member 196 directly faces the coupling lever 192, and the coupling lever 192 is able to move in the shift direction through the inside of the notch portion 222.

Therefore, according to the shift lever device 190, when the shift lever 14 is manipulated from the manual gear change area 108 to the automatic gear change area 106, the control lever 60 that has been coupled to the coupling lever 192 is able to move along the shift direction, and also since the control lever 60 is coupled to the shift lever 14 that has returned to the automatic gear change area 106, the control lever 60 becomes in the state of moving along the shift direction integrally to the shift lever 14.

As explained above the shift lever device according to the first exemplary embodiment of the present invention includes a shift lever, a control lever, a lever member, a striker member, and a stopper member. The shift lever is moveable along a first manipulation direction and a second manipulation direction that are substantially orthogonal to each other. The shift lever is moveable to a desired shift position in an automatic gear change mode selection area by manipulation along the first manipulation direction and the second manipulation direction. Also, when the shift lever is manipulated toward one end side along the second manipulation direction from a particular shift position in the automatic gear change mode selection area, the shift lever moves from the automatic gear change mode selection area to a manual gear change mode selection area, and when the shift lever is manipulated from the manual gear change mode selection area toward the other end side in the second manipulation direction, the shift lever returns to the automatic gear change mode selection area from the manual gear change mode selection area. The control lever is moveable in the first manipulation direction and is coupled to a gear change device, and when the shift lever is in the automatic gear change mode selection area, the control lever becomes coupled integrally to the shift lever and moves in the first manipulation direction, and when the shift lever moves from the automatic gear change mode selection area to the manual gear change mode selection area, the coupled state of the control lever to the shift lever is released. The lever member is coupled to the control lever so as to move integrally with the control lever along the first manipulation direction. The striker member is supported by the lever member so as to be moveable between a predetermined released position and a predetermined constrained position. The striker member also engages with the shift lever, and when the shift lever moves from the automatic gear change mode selection area to the manual gear change mode selection area, the striker member moves from the released position to the constrained position, and when the shift lever returns to the automatic gear change mode selection area from the manual gear change mode selection area, the striker member returns to the released position from the constrained position. The stopper member prevents movement along the first manipulation direction of the lever member when the striker member is in the constrained position, and the stopper member permits movement along the first manipulation direction of the lever member when the striker member is returned to the released position.

According to the shift lever device described above, when the shift lever is manipulated from a particular shift position in the automatic gear change mode selection area, coupled to this movement, by the striker member moving from the released position to the constrained position, the stopper member, through the striker member in the constrained position, prevents movement of the lever member and the contorol lever along the first manipulation direction.

Therefore, when the shift lever is moved from the automatic gear change mode selection area to the manual gear change mode selection area, since movement of the control lever that is in the particular shift position in the automatic gear change mode selection area along the first manipulation direction is prevented, when the coupled state of the shift lever with the control lever is released, the control lever may be prevented from moving from the particular shift position.

Furthermore, when the shift lever returns to the particular shift position in the automatic gear change mode selection area from the manual gear change mode selection area, coupled to this movement, the stopper member permits the striker member to move along the first manipulation direction by the striker member being returned to the released position from the constrained position.

Therefore, the control lever that has been coupled to the striker member through the lever member is able to move along the first manipulation direction and also since the control lever is coupled to the shift lever that has returned to the automatic gear change mode selection area, a state has been arrived at in which the control lever is integrated to the shift lever and moves in the first manipulation direction.

In the above aspect, the striker member may be supported by the lever member so as to be able to slide between the released position and the constrained position along a width direction that is substantially parallel to the second manipulation direction.

In the aspect described above, it may be configured such the striker member is coupled to the lever member through a coupling shaft with an axial direction that is substantially in the first manipulation direction, and when the shift lever moves from the automatic gear change mode selection area to the manual gear change mode selection area, the striker member swings about the coupling shaft as a center from the released position to the constrained position, and when the shift lever returns to the automatic gear change mode selection area from the manual gear change mode selection area, the striker member swings about the coupling shaft as the center from the constrained position to the released position.

A shift lever device according to a second exemplary embodiment of the present invention includes a shift lever, a control lever, a lever member, a stopper member, and a constraining member. The shift lever is moveable along a first manipulation direction and a second manipulation direction that are substantially orthogonal to each other and the shift lever is moveable to a desired shift position in an automatic gear change mode selection area by manipulation along the first manipulation direction and the second manipulation direction. Also, when the shift lever is manipulated toward one end side along the second manipulation direction from a particular shift position in the automatic gear change mode selection area, the shift lever moves from the automatic gear change mode selection area to a manual gear change mode selection area, and when the shift lever is manipulated from a particular shift position in the manual gear change mode selection area toward the other end side in the second manipulation direction, the shift lever returns to the automatic gear change mode selection area from the manual gear change mode selection area. The control lever is moveable in the first manipulation direction and is coupled to a gear change device, and when the shift lever is in the automatic gear change mode selection area, the control lever becomes coupled and integrated to the shift lever and moves in the first manipulation direction, and when the shift lever moves from the automatic gear change mode selection area to the manual gear change mode selection area, the coupled state of the control lever to the shift lever is released. The lever member is coupled to the control lever so as to move integrally with the control lever along the first manipulation direction. The stopper member is moveable along a width direction that is substantially parallel to the second manipulation direction between a predetermined constrained position and a predetermined released position. Also the stopper member is coupled to the shift lever, and when the shift lever moves from the automatic gear change mode selection area to the manual gear change mode selection area, the stopper member moves from the released position to the constrained position, and when the shift lever returns to the automatic gear change mode selection area from the manual gear change mode selection area, the stopper member returns to the released position from the constrained position. The constraining member is formed integrally to the stopper member, and when moves to the constrained position the constraining member prevents movement of the lever member along the first manipulation direction, and when moves to the released position the constraining member permits movement of the lever member along the first manipulation direction.

In the shift lever device according to the above described aspect, when the shift lever moves from the particular shift position in the automatic gear change mode selection area to the manual gear change mode selection area, coupled to this movement, the stopper member moves along the second manipulation direction from the released position to the constrained position, and thereby the constraining member that is formed integrally to the stopper member, prevents the control lever that is in the particular shift position from moving along the first manipulation direction, through the lever member.

Therefore, when the shift lever moves from the automatic gear change mode selection area to the manual gear change mode selection area, the control lever that is in the particular shift position in the automatic gear change mode selection area is prevented from moving along the first manipulation direction, and the even though the coupled state between the shift lever and the control lever is released, the control lever may be prevented from moving from the particular shift position.

Furthermore, when the shift lever returns to the particular shift position in the automatic gear change mode selection area, coupled to this movement, the stopper member returns to the released position from the constrained position, and thereby the constraining member that has been formed integrated to the stopper member permits the lever member to move along the first manipulation direction.

Therefore, when the shift lever returns to the particular shift position in the automatic gear change mode selection area from the manual gear change mode selection area, the control lever that has been coupled to the lever member is able to move along the first manipulation direction and also, since the control lever is coupled to the shift lever that has returned to the automatic gear change mode selection area, the control lever is able to move integrally with the shift lever along the first manipulation direction.

As explained above, according to the shift lever device of the present invention, when the shift lever moves from the particular shift position in the automatic gear change mode selection area to the manual gear change mode selection area, even if the coupled state of the control lever with the shift lever is released, the control lever may be prevented from moving from the particular shift position.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention from various embodiments and with the various modifications as are suited to the particular use contemplated. It is intended that the scope of the invention be defined by the following claims and their equivalents.

What is claimed is:

1. A shift lever device comprising:
a shift lever, the shift lever being moveable along a first manipulation direction and a second manipulation direction that are substantially orthogonal to each other, the shift lever being moveable to a desired shift position in an automatic gear change mode selection area by manipulation along the first manipulation direction and the second manipulation direction, and when the shift lever is manipulated toward one end side along the second manipulation direction from a particular shift position in the automatic gear change mode selection area, the shift lever moves from the automatic gear change mode selection area to a manual gear change mode selection area, and when the shift lever is manipulated from the manual gear change mode selection area toward the other end side in the second manipulation direction, the shift lever returns to the automatic gear change mode selection area from the manual gear change mode selection area;
a control lever, the control lever being moveable in the first manipulation direction and being coupled to a gear change device, and when the shift lever is in the automatic gear change mode selection area, the control lever becomes coupled integrally to the shift lever and moves in the first manipulation direction, and when the shift lever moves from the automatic gear change mode selection area to the manual gear change mode selection area, the coupled state of the control lever to the shift lever is released;
a lever member, the lever member being coupled to the control lever so as to move integrally with the control lever along the first manipulation direction;
a striker member, the striker member being supported by the lever member so as to be moveable between a predetermined released position and a predetermined constrained position and the striker member also engaging with the shift lever, and when the shift lever moves from the automatic gear change mode selection area to the manual gear change mode selection area, the striker member moves from the released position to the constrained position, and when the shift lever returns to the automatic gear change mode selection area from the manual gear change mode selection area, the striker member returns to the released position from the constrained position; and
a stopper member, the stopper member preventing movement along the first manipulation direction of the lever member when the striker member is in the constrained position, and the stopper member permitting movement along the first manipulation direction of the lever member when the striker member is returned to the released position.

2. The shift lever device according to claim 1, wherein:
the striker member is supported by to the lever member so as to be able to slide between the released position and the constrained position along a width direction that is substantially parallel to the second manipulation direction.

3. The shift lever device according to claim 1, wherein:
the striker member is coupled to the lever member through a coupling shaft with an axial direction that is substantially in the first manipulation direction, and when the shift lever moves from the automatic gear change mode selection area to the manual gear change mode selection area, the striker member swings about the coupling shaft as a center from the released position to the constrained position, and when the shift lever returns to the automatic gear change mode selection area from the manual gear change mode selection area, the striker member swings about the coupling shaft as the center from the constrained position to the released position.

4. A shift lever device comprising:
a shift lever, the shift lever being moveable along a first manipulation direction and a second manipulation direction that are substantially orthogonal to each other, the shift lever being moveable to a desired shift position in an automatic gear change mode selection area by manipulation along the first manipulation direction and the second manipulation direction, and when the shift lever is manipulated toward one end side along the second manipulation direction from a particular shift position in the automatic gear change mode selection area, the shift lever moves from the automatic gear change mode selection area to a manual gear change mode selection area, and when the shift lever is manipulated from a particular shift position in the manual gear change mode selection area toward the other end side in the second manipulation direction, the shift lever returns to the automatic gear change mode selection area from the manual gear change mode selection area;
a control lever, the control lever being moveable in the first manipulation direction and being coupled to a gear change device, and when the shift lever is in the automatic gear change mode selection area, the control lever becomes coupled integrally to the shift lever and moves in the first manipulation direction, and when the shift lever moves from the automatic gear change mode selection area to the manual gear change mode selection area, the coupled state of the control lever to the shift lever is released;
a lever member, the lever member being coupled to the control lever so as to move integrally with the control lever along the first manipulation direction;
a stopper member, the stopper member being moveable along a width direction that is substantially parallel to the second manipulation direction between a predetermined constrained position and a predetermined released position, and also the stopper member being coupled to the shift lever, and when the shift lever moves from the automatic gear change mode selection area to the manual gear change mode selection area, the stopper member moves from the released position to the constrained position, and when the shift lever returns to the automatic gear change mode selection area from the manual gear change mode selection area, the stopper member returns to the released position from the constrained position; and
a constraining member, the constraining member being formed integrally to the stopper member, and when moves to the constrained position the constraining member prevents movement of the lever member along the first manipulation direction, and when is returned to the released position the constraining member permitting movement of the lever member along the first manipulation direction.
